(19) United States
(12) Patent Application Publication
(10) Pub. No.: US 2009/0165604 A1
(43) Pub. Date: Jul. 2, 2009

(54) Engaging portion of a screwdriver

(76) Inventor: Richard J. Macor, Asbury, NJ (US)

Correspondence Address: Richard J. Macor;Proprietary Technologies, Inc., 26 Alpaugh Drive, Asbury, NJ, 08802-1213, US

(21) Appl. No.: 12/154,370

(22) Filed: May 22, 2008

Related U.S. Application Data
(63) Continuation-in-part of application No. 29/294,259, filed on Dec. 31, 2007, now Pat. No. D583642.

(51) Int. Cl. B25B 23/00; B25B 15/00

(52) U.S. Cl. 81/436

(57) ABSTRACT

An engaging portion of a screwdriver formed for engagement with a work-piece such as a screw, is described. The engaging portion comprises an imaginary central axis, a tip, a front face, a rear face, and a profile shape when viewed from a front view thereof. The tip has two outer ends. The profile shape is defined by the tip and two profile sides. Each profile side extends from an outer end of the tip, for at least a short distance, at a predetermined relationship to the central axis. Each face comprises side outer engaging edges. Each outer engaging edge extends from an outer end of the tip, for at least a short distance, at a predetermined relationship to the central axis. And, when viewed from a front view thereof the predetermined relationship of each profile side to the imaginary central axis is different than the predetermined relationship of each outer engaging edge to the imaginary central axis.

### REFERENCES TO RELATED APPLICATIONS

This application relates to, and is a continuation-in-part of co-pending U.S. patent application Ser. No. 29/294,259 filed on Dec. 31, 2007 entitled SCREWDRIVER BLADE TIP, also filed by the inventor herein.

### FIELD OF THE INVENTION

The present invention relates to hand tool devices, particularly screwdrivers, and more particularly screwdrivers referred to in the industry as slotted type.

### BACKGROUND OF THE INVENTION

Screwdrivers have been around for hundreds of years and the slotted type screwdrivers (which is the only type addressed herein) generally have a fixed blade formed to fit within an elongated slot of a work-piece such as a screw etc., to turn the work-piece. When using this screwdriver, users often encounter engagement failures, whereas, the screwdriver tip slips out of the slot of the work-piece under torque loading. Engagement failures often result in damage to the work-piece, damage to the screwdriver, and sometimes user injury. The engaging portion of a typical, prior art slotted screwdriver often has a profile tapering outwardly from its tip to enhance strength, however, this outward taper tends to promote cam-out and disengagement with a work-piece such as a screw. “Cam-out” is referred to herein as the disengagement of the engaging portion of a screwdriver with a work-piece such as a screw, resulting from the outwardly tapered engaging edges of the screwdriver engaging with the walls of a slot having a lesser taper (or no taper) thereby urging the engaging portion of the screwdriver out of the slot of the work-piece. Alternatively, if the engaging portion of a screwdriver has a profile that tapers inwardly from the tip this may reduce cam-out and engagement failures, but strength is compromised. In fact, if heavy torque is applied to the engaging portion of a screwdriver with a profile tapering inwardly from its tip, this can result in permanent deformation of the screwdriver blade and tip.

Over the past few decades, new engagement designs have come about including the use of micro-grooves placed across the screwdriver face at the tip to enhance the coefficient of friction between the screwdriver tip and work-piece. However, engagement between a traditional screwdriver and work-piece often occurs only at diagonally opposed engaging edges close to the terminal end of the tip, and therefore, most of the micro-grooves are not actually involved in the engagement process. Accordingly, this means often provides only a minimal benefit.

Therefore when considering the above, applicant believes there is a valid need to achieve effective engagement between a slotted type screwdriver and slotted work-piece such as a screw etc., to reduce the potential of cam-out and disengagement under torque.

### SUMMARY OF THE INVENTION

In one embodiment, the present invention is an engaging portion of a screwdriver formed for engagement with a work-piece such as a screw. The engaging portion comprises an imaginary central axis, a tip, a front face, a rear face, and a profile shape when viewed from a front view thereof. The tip has two outer ends. The profile shape is defined by the tip and two profile sides. Each profile side extends from an outer end of the tip, for at least a short distance, at a predetermined relationship to the central axis. Each face comprises side outer engaging edges. Each outer engaging edge extends from an outer end of the tip, for at least a short distance, at a predetermined relationship to the central axis. And, when viewed from a front view thereof the predetermined relationship of each profile side to the imaginary central axis is different than the predetermined relationship of each outer engaging edge to the imaginary central axis.

Relative to the foregoing, applicant considers the following objectives.

It is an important objective of the present invention to improve the interaction and engagement between a slotted type screwdriver and slotted work-piece such as a screw etc., to reduce the potential of cam-out and disengagement under torque.

And, it is another important objective of the present invention that the strength and durability of the engaging portion of the screwdriver be equal to or greater than the prior art versions.

And, it is yet another important objective of the present invention that the screwdriver be cost-efficient to manufacture and commercially viable.

### BRIEF DESCRIPTION OF THE DRAWINGS

FIG. 1 shows a front, cut view of the engaging portion of a prior art slotted type screwdriver; and,

FIG. 2 shows a right side, cut view of the prior art slotted type screwdriver shown in FIG. 1; and,

FIG. 3 shows a front, cut view of the engaging portion of another prior art slotted type screwdriver; and,

FIG. 4 shows a right side, cut view of the prior art slotted type screwdriver shown in FIG. 3; and,

FIG. 5 shows a front, cut view of the engaging portion of a present invention slotted type screwdriver; and,

FIG. 6 shows a right side, cut view of the present invention slotted type screwdriver shown in FIG. 5; and,

FIG. 7 shows a front, cut view of the engaging portion of another embodiment of the present invention slotted type screwdriver; and,

FIG. 8 shows a right side, cut view of the present invention slotted type screwdriver shown in FIG. 7; and,

FIG. 9 shows a front, cut view of the engaging portion of yet another embodiment of the present invention slotted type screwdriver; and,

FIG. 10 shows a right side, cut view of the present invention slotted type screwdriver shown in FIG. 9; and,

FIG. 11 shows a front, cut view of the engaging portion of yet another embodiment of the present invention slotted type screwdriver; and,

FIG. 12 shows a right side, cut view of the present invention slotted type- screwdriver shown in FIG. 11.

### DETAILED DESCRIPTION OF THE DRAWINGS

The various drawings provided herein are for the purpose of illustrating possible embodiments of the present invention and not for the purpose of limiting same. Therefore, the drawings herein represent only a few of the many possible embodiments, variations and/or applications of the present invention.

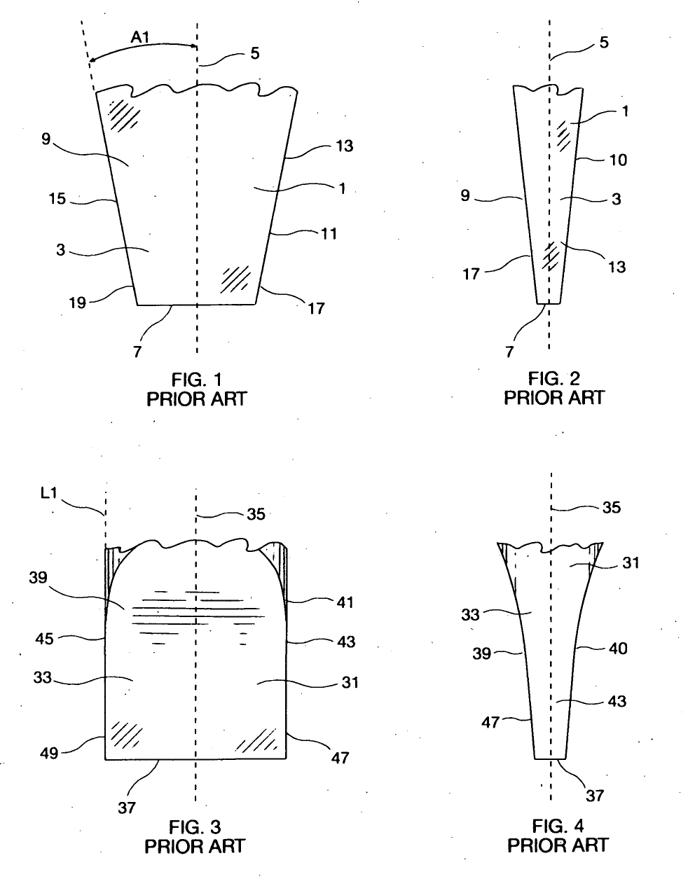

FIG. 1 shows a front, cut view of the engaging portion of a prior art slotted type screwdriver, wherein screwdriver 1 has an engaging portion 3, an imaginary central axis 5, a tip 7, a front face 9, and a rear face not shown in this front view. Engaging portion 3 also has a profile shape 11 when viewed in this front view which is defined by tip 7 and profile sides 13 and 15. Profile sides 13 and 15 each extend from tip 7 for at least a short distance at a predetermined relationship to the central axis 5 as shown. Profile sides 13 and 15 each extend in a direction outward away from imaginary central axis 5 at an angle Al which is about 8 degrees or so. Front face 9 of engaging portion 3 has side outer engaging edges 17 and 19 each of which extend from the tip 7 for at least a short distance at a predetermined relationship to central axis 5. This predetermined relationship is also defined by angle Al and the same predetermined relationship of profile sides 13 and 15 to imaginary central axis 5. It's important to note that the “at least a short distance” relates to the slot depth of the intended work piece, and therefore, the distance could be very short. Virtually all prior art, slotted type screwdrivers have outer engaging edges that are in alignment with the profile sides of the screwdriver, for at least a short distance equal to the slot depth of the intended work-piece, when viewed from a front view thereof. This structural feature defines most prior art screwdrivers, whereas, the profile sides 13 and 15 of the engaging portion 3 extend from the tip 7, at least for a short distance, at a predetermined relationship to an imaginary central axis 5 which is the same as the predetermined relationship at which the outer engaging edges 17 and 19 extend from the tip 7, at least for a short distance. This is because outer engaging edges 17 and 19 are structurally formed in-part by their counterpart profile sides 13 and 15 respectively.

FIG. 2 shows a right side, cut view of the prior art slotted type screwdriver shown in FIG. 1. Reference numbers are the same as FIG. 1, with rear face 10 now partially visible in this view.

FIG. 3 shows a front, cut view of the engaging portion of another prior art slotted type screwdriver, wherein screwdriver 31 has an engaging portion 33, an imaginary central axis.35, a tip 37, a front face 39, and a rear face not shown in this front view. Engaging portion 33 also has a profile shape 41 when viewed in this front view which is defined by tip 37 and profile sides 43 and 45. Profile sides 43 and 45 each extend from tip 37 for at least a short distance at a predetermined relationship to the central axis 35 as shown. Profile sides 43 and 45 each extend in a direction defined by imaginary line L1 which is substantially parallel to imaginary central axis 35 as shown. Front face 39 of engaging portion 33 has side outer engaging edges 47 and 49 each of which extend from the tip 37 for at least a short distance at a predetermined relationship to central axis 35. This predetermined relationship is also defined by imaginary line L1 which is also about parallel to imaginary central axis 35. It's important to note that the “at least a short distance” relates to the slot depth of the intended work piece, and therefore, the distance could be very short. Virtually all prior art, slotted type screwdrivers have outer engaging edges that are in alignment with the profile sides of the screwdriver, for at least a short distance equal to the slot depth of the intended work-piece, when viewed from a front view thereof. This structural feature defines most prior art screwdrivers, whereas, the profile sides 43 and 45 of the engaging portion 33 extend from the tip 37, at least for a short distance, at a predetermined relationship to an imaginary central axis 35 which is the same as the predetermined relationship at which the outer engaging edges 47 and 49 extend from the tip 37, at least for a short distance. This is because outer engaging edges 47 and 49 are structurally formed in-part by their counterpart profile sides 43 and 45 respectively.

FIG. 4 shows a right side, cut view of the prior art slotted type screwdriver shown in FIG. 3. Reference numbers are the same as FIG. 3, with rear face 40 now partially visible in this view.

Therefore, each profile side of both the typical prior art screwdrivers described above in FIGS. 1 and 3 has a predetermined relationship to the imaginary central axis which is the same as the predetermined relationship of each outer engaging edge to the imaginary central axis, regardless of whether or not the profile sides taper out or remain parallel to the imaginary central axis.

FIG. 5 shows a front, cut view of the engaging portion of a present invention slotted type screwdriver. The backside, not shown, is a mirror view of the front view shown here. In this example embodiment, engaging portion 53 of a screwdriver 51 is formed for engagement with a slotted work-piece such as a screw (not shown). The engaging portion 53 comprises an imaginary central axis 55, a tip 57, a front face 59, and a rear face not shown in this view. Engaging portion 53 also has a profile shape 61 when viewed from this front view. Tip 57 has two outer ends 56 and 58. The “outer end” of a tip shall be defined herein as a small region of the tip at or proximate to one of its lateral outermost ends. The profile shape 61 is generally defined by tip 57 and profile sides 63 and 65. Profile sides 63 and 65 each extend from tip outer ends 56 and 58 respectively, for at least a short distance, at a predetermined relationship to central axis 55 which is defined by angle A3. Face 59 comprises side outer engaging edges 67 and 69. Outer engaging edge 67 extends from outer end 56 of tip 57, for at least a short distance, at a predetermined relationship to central axis 55 as shown. And, outer engaging edge 69 extends from outer end 58 of tip 57, for at least a short distance, at a predetermined relationship to central axis 55 as viewed from this a front view. It's important to note that the “at least a short distance” relates to the slot depth of the intended work piece, and therefore, the distance could be very short. When considering leverage and lateral length of tip 57, it's preferable that the outer engaging edges 67 and 69 each originate at or close to outer ends 56 and 58 respectively of tip 57. Nonetheless, outer engaging edges 67 and 69 do not have to extend from the outermost ends of tip 57, and could also each originate and extend from tip 57 in a region close to outer ends 56 and 58 respectively. When considering strength, it's preferable that the profile sides 63 and 65 each extend, at least for a short distance, outwardly away from imaginary central axis 55. And, when considering effective engagement between the engaging portion of the screwdriver and a work-piece, the actual engaging edges 67 and 69 should preferably extend, at least for a short distance, inward towards imaginary central axis 55 to minimize engagement failures including cam-out.

So then, therefore, in this example embodiment of the present invention, the predetermined relationship of each profile side 63 and 65 to imaginary central axis 55 is very different than the predetermined relationship of corresponding outer engaging edges 67 and 69 respectively, to imaginary central axis 55. Clearly, this differentiates the aforementioned prior art screwdrivers shown in FIGS. 1 and 3 from this example embodiment of the present invention shown in FIG. 5. The present invention screwdriver may have outer engaging edges that are arcuate, straight or any combination thereof. The addition of serrations or micro-grooves across face 59 in the area of tip 57 may enhance engagement and can be added without departing from the scope of the invention. Preferred embodiments of the present invention include outer engaging edges such as 67 and 69 that are substantially actuate and extend from the tip 57 in a direction towards the imaginary central axis 85, at least for a short distance. More preferred embodiments of the present invention have outer engaging edges such as 67 and 69 that each extend from the tip 57 in a direction towards the imaginary central axis 55, and then diverge outward away from the imaginary central axis. And, most preferred embodiments of the present invention have outer engaging edges such as 67 and 69 that are formed arcuate with a curvature substantially convex to the imaginary central axis 55 as shown in this FIG. 5.

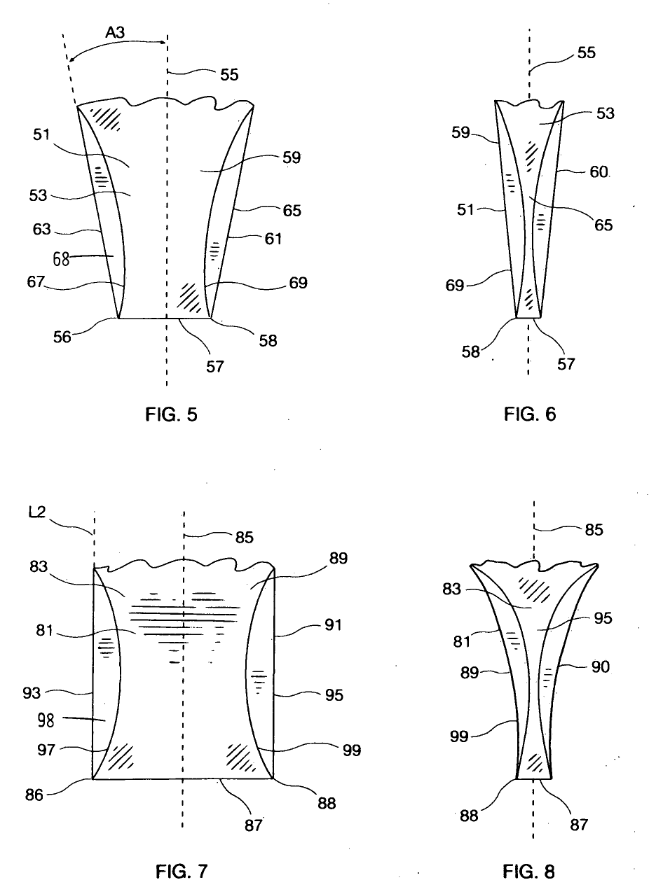

FIG. 6 shows a right side, cut view of the example embodiment of the present invention screwdriver shown in FIG. 5. The left side (not shown) is a mirror view of the right side shown. Reference numbers are the same as FIG. 5, with rear face 60 now partially visible in this view. The structure of this screwdriver shown here in FIGS. 5 and 6 enables the outer engaging edges to bite into the lower area of a work piece slot, urging the engaging portion of the screwdriver into the slot during torque loading, thereby improving effective engagement and reducing the aforementioned engagement failures including cam-out.

FIG. 7 shows a front, cut view of the engaging portion of another present invention slotted type screwdriver. The backside, not shown, is a mirror view of the front view shown here. In this example embodiment, engaging portion 83 of a screwdriver 81 is formed for engagement with a slotted work-piece such as a screw (not shown). The engaging portion 83 comprises an imaginary central axis 85, a tip 87, a front face 89, and a rear face not shown in this view. Engaging portion 83 also has a profile shape 91 when viewed from this front view. Tip 87 has two outer ends 86 and 88. The “outer end” of a tip shall be defined herein as a region of the tip at or proximate to one of its lateral outermost ends. The profile shape 91 is generally defined by tip 87 and profile sides 93 and 95. Profile sides 93 and 95 each extend from tip outer ends 86 and 88 respectively, for at least a short distance, at a predetermined relationship to central axis 85 which is defined by line L2 which is about parallel to imaginary central axis 85. Face 89 comprises side outer engaging edges 97 and 99. Outer engaging edge 97 extends from outer end 86 of tip 87, for at least a short distance, at a predetermined relationship to central axis 85 as shown. And, outer engaging edge 99 extends from outer end 88 of tip 87, for at least a short distance, at a predetermined relationship to central axis 85 as viewed from this front view. It's important to note that the “at least a short distance” relates to the slot depth of the intended work piece, and therefore, the distance could be very short. When considering leverage and lateral length of tip 87, it's preferable that the outer engaging edges 97 and 99 each originate at or close to outer ends 86 and 88 respectively of tip 87. And, when considering effective engagement between the engaging portion of the screwdriver and a work-piece, the actual engaging edges 97 and 99 should preferably extend, at least for a short distance, inward towards imaginary central axis 85 to minimize engagement failures including cam-out.

So then, therefore, in this example embodiment of the present invention, the predetermined relationship of each profile side 93 and 95 to imaginary central axis 85 is very different than the predetermined relationship of corresponding outer engaging edges 97 and 99 respectively, to imaginary central axis 85. Clearly, this differentiates the aforementioned prior art screwdrivers shown in FIGS. 1 and 3 from this example embodiment of the present invention shown in FIG. 7. The present invention screwdriver may have outer engaging edges that are arcuate, straight or any combination thereof. The addition of serrations or micro-grooves across face 89 in the area of tip 87 may enhance engagement and can be added without departing from the scope of the invention. Preferred embodiments of the present invention include outer engaging edges such as 97 and 99 that are substantially arcuate and extend from the tip 87 in a direction towards the imaginary central axis 85, at least for a short distance. More preferred embodiments of the present invention have outer engaging edges such as 97 and 99 that each extend from the tip 87 in a direction towards the imaginary central axis 85, and then diverge outward away from the imaginary central axis. And, most preferred embodiments of the present invention have outer engaging edges such as 97 and 99 that are formed arcuate with a curvature substantially convex to the imaginary central axis 85 as shown in this FIG. 7.

FIG. 8 shows a right side, cut view of the example embodiment of the present invention screwdriver shown in FIG. 7. The left side (not shown) is a mirror view of the right side shown. Reference numbers are the same as FIG. 7, with rear face 90 now partially visible in this view. The structure of this screwdriver shown here in FIGS. 7 and 8 enables the outer engaging edges to bite into the lower area of a work piece slot, urging the engaging portion of the screwdriver into the slot during torque loading, thereby improving effective engagement and reducing the aforementioned engagement failures including cam-out.

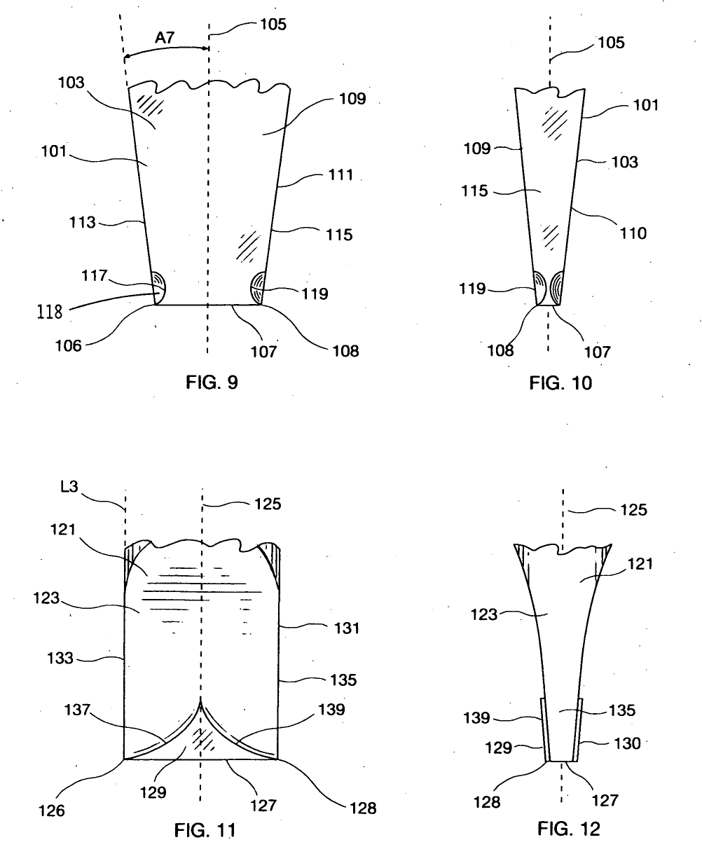

FIG. 9 shows a front, cut view of the engaging portion of another present invention slotted type screwdriver. The backside, not shown, is a mirror view of the front view shown here. In this example embodiment, engaging portion 103 of a screwdriver 101 is formed for engagement with a slotted work-piece such as a screw (not shown). The engaging portion 103 comprises an imaginary central axis 105, a tip 107, a front face 109, and a rear face not shown in this view. Engaging portion 103 also has a profile shape 111 when viewed from this front view. Tip 107 has two outer ends 106 and 108. The “outer end” of a tip shall be defined herein as a small region of the tip at or proximate to one of its lateral outermost ends. The profile shape 111 is generally defined by tip 107 and profile sides 113 and 115. Profile sides 113 and 115 each extend from tip outer ends 106 and 108 respectively, for at least a short distance, at a predetermined relationship to central axis 105 which is defined by angle A7. Face 109 comprises side outer engaging edges 117 and 119. Outer engaging edge 117 extends from outer end 106 of tip 107, for at least a short distance, at a predetermined relationship to central axis 105 as shown. And, outer engaging edge 119 extends from outer end 108 of tip 107, for at least a short distance, at a predetermined relationship to central axis 105 as viewed from this a front view. It's important to note that the “at least a short distance” relates to the slot depth of the intended work piece, and therefore, the distance could be very short. When considering leverage and lateral length of tip 107, it's preferable that the outer engaging edges 117 and 119 each originate at or close to outer ends 106 and 108 respectively of tip 107. When considering strength, it's preferable that the profile sides 113 and 115 each extend, at least for a short distance, outwardly away from imaginary central axis 105. And, when considering effective engagement between the engaging portion of the screwdriver and a work-piece, the actual engaging edges 117 and 119 should preferably extend, at least for a short distance, inward towards imaginary central axis 105 to maximize effective engagement and minimize engagement failures including cam-out.

So then, therefore, in this example embodiment of the present invention, the predetermined relationship of each profile side 113 and 115 to imaginary central axis 105 is very different than the predetermined relationship of corresponding outer engaging edges 117 and 119 respectively, to imaginary central axis 105. Clearly, this differentiates the aforementioned prior art screwdrivers shown in FIGS. 1 and 3 from this example embodiment of the present invention shown in FIG. 9. The present invention screwdriver may have outer engaging edges that are arcuate, straight or any combination thereof. The addition of serrations or micro-grooves across face 109 in the area of tip 107 may enhance engagement and can be added without departing from the scope of the invention. Nonetheless, the use of serrations and/or micro-grooves is well known in the art and not the subject of this invention nor shown in this view. Preferred embodiments of the present invention include outer engaging edges such as 117 and 119 that are substantially arcuate and extend from the tip 107 in a direction towards the imaginary central axis 105, at least for a short distance. More preferred embodiments of the present invention have outer engaging edges such as 117 and 119 that each extend from the tip 107 in a direction towards the imaginary central axis 105, and then diverge outward away from the imaginary central axis. And, most preferred embodiments of the present invention have outer engaging edges such as 117 and 119 that are formed arcuate with a curvature substantially convex to the imaginary central axis 105 as shown in this FIG. 9.

FIG. 10 shows a right side, cut view of the example embodiment of the present invention screwdriver shown in FIG. 9. The left side (not shown) is a mirror view of the right side shown. Reference numbers are the same as FIG. 9, with rear face 110 now partially visible in this view. The structure of this screwdriver shown here in FIGS. 9 and 10 enables the outer engaging edges to bite into the lower area of a work piece slot, urging the engaging portion of the screwdriver into the slot while under torque thereby improving effective engagement and reducing the aforementioned engagement failures including cam-out, without sacrificing strength.

FIG. 11 shows a front, cut view of the engaging portion of another present invention slotted type screwdriver. The backside, not shown, is a mirror view of the front view shown here. In this example embodiment, engaging portion 123 of a screwdriver 121 is formed for engagement with a slotted work-piece such as a screw (not shown). The engaging portion 123 comprises an imaginary central axis 125, a tip 127, a front face 129, and a rear face not shown in this view. Engaging portion 123 also has a profile shape 131 when viewed from this front view. Tip 127 has two outer ends 126 and 128. The “outer end” of a tip shall be defined herein as a small region of the tip at or proximate to one of its lateral outermost ends. The profile shape 131 is generally defined by tip 127 and profile sides 133 and 135. Profile sides 133 and 135 each extend from tip outer ends 126 and 128 respectively, for at least a short distance, at a predetermined relationship to central axis 125 which is defined by line L3 which is about parallel to imaginary central axis 125. Face 129 comprises side outer engaging edges 137 and 139. Outer engaging edge 137 extends from outer end 126 of tip 127, for at least a short distance, at a predetermined relationship to central axis 125 as shown. And, outer engaging edge 139 extends from outer end 128 of tip 127, for at least a short distance, at a predetermined relationship to central axis 125 as viewed from this a front view. It's important to note that the “at least a short distance” relates to the slot depth of the intended work piece, and therefore, the distance could be very short. When considering leverage and lateral length of tip 127, it's preferable that the outer engaging edges 137 and 139 each originate at or close to outer ends 126 and 128 respectively of tip 127. And, when considering effective engagement between the engaging portion of the screwdriver and a work-piece, the actual engaging edges 137 and 139 should each preferably extend, at least for a short distance, inward towards imaginary central axis 125 to minimize engagement failures including cam-out.

So then, therefore, in this example embodiment of the present invention, the predetermined relationship of each profile side 133 and 135 to imaginary central axis 125 is very different than the predetermined relationship of corresponding outer engaging edges 137 and 139 respectively, to imaginary central axis 125. Clearly, this differentiates the aforementioned prior art screwdrivers shown in FIGS. 1 and 3 from this example embodiment of the present invention shown in FIG. 11. The present invention screwdriver may have outer engaging edges that are arcuate, straight or any combination thereof. The addition of serrations or micro-grooves across face 129 in the area of tip 127 may enhance engagement and can be added without departing from the scope of the invention. Preferred embodiments of the present invention include outer engaging edges such as 137 and 139 that are substantially arcuate and extend from the tip 127 in a direction towards the imaginary central axis 125, at least for a short distance. More preferred embodiments of the present invention have outer engaging edges such as 137 and 139 that each extend from the tip 127 in a direction towards the imaginary central axis 125, and then diverge outward away from the imaginary central axis. And, most preferred embodiments of the present invention have outer engaging edges such as 137 and 139 that are formed arcuate with a curvature substantially convex to the imaginary central axis 125 as shown in this FIG. 11.

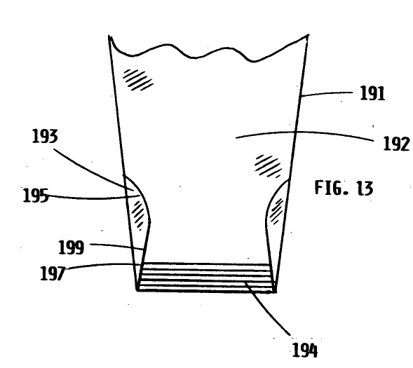

FIG. 12 shows a right side, cut view of the example embodiment of the present invention screwdriver shown in FIG. 11. The left side (not shown) is a mirror view of the right side shown. Reference numbers are the same as Figure. 11, with rear face 130 now partially visible in this view. The structure of this screwdriver shown here in FIGS. 11 and 12 enables the outer engaging edges 137 and 139 to bite into the lower area of a work piece slot, urging the engaging portion of the screwdriver into the slot while under torque thereby improving effective engagement and reducing the aforementioned engagement failures including cam-out.

It is believed that the present invention disclosed herein will have many applications to slotted type screwdrivers. When considering the present invention, simplicity and obviousness should not be confused or considered the same.

Upon reading and understanding the specification of the present invention described above, modifications and alterations will become apparent to those skilled in the art. It is intended that all such modifications and alterations be included insofar as they come within the scope of the patent as claimed or the equivalence thereof.

1-20. (canceled)

21. An engaging portion of a screwdriver formed for engagement with a slotted work-piece such as a screw; said engaging portion comprising an imaginary central axis, a tip, a front face, a rear face, and a profile shape when viewed from a front view thereof; the tip having two outer ends, the profile shape being defined by the tip and two profile sides each extending from an outer end of the tip, for at least a short distance, at a predetermined relationship to said central axis, each said face comprising side outer engaging edges, each said outer engaging edge extending from an outer end of the tip in a direction inwardly towards said imaginary central axis at least for a short distance, and then outwardly away from said imaginary central axis, and, when viewed from a front view thereof with said tip down each said outer engaging edge being adjacent to an elongated groove, each elongated groove having dimensions of height greater than width when measured square to said imaginary central axis.

22. The engaging portion of a screwdriver defined in claim 21, wherein each profile side extends from an outer end of the tip, for at least a short distance, in a direction away from said imaginary central axis.

23. The engaging portion of a screwdriver defined in claim 21, wherein each profile side extends from an outer end of the tip, for at least a short distance, substantially parallel to said imaginary central axis as viewed from a front view thereof.

24. The engaging portion of a screwdriver defined in claim 21, wherein each said face comprises at least one lateral groove proximate said tip to enhance the engagement of said screwdriver with said work-piece.

25. The engaging portion of a screwdriver defined in claim 21, wherein at least one said outer engaging edge is substantially arcuate, at least for a short distance, as viewed from a front view thereof.

26. The engaging portion of a screwdriver defined in claim 21, wherein at least one said outer engaging edge is substantially straight, at least for a short distance; as viewed from a front view thereof.

27. The engaging portion of a screwdriver defined in claim 22, wherein at least one said outer engaging edge is substantially arcuate, at least for a short distance, as viewed from a front view thereof.

28. The engaging portion of a screwdriver defined in claim 22, wherein at least one said outer engaging edge is substantially straight, at least for a short distance, as viewed from a front view thereof.

29. The engaging portion of a screwdriver defined in claim 23, wherein at least one said outer engaging edge is substantially arcuate, at least for a short distance, as viewed from a front view thereof.

30. The engaging portion of a screwdriver defined in claim 23, wherein at least one said outer engaging edge is substantially straight, at least for a short distance, as viewed from a front view thereof.

31. The engaging portion of a screwdriver defined in claim 24, wherein at least one said outer engaging edge is substantially arcuate, at least for a short distance, as viewed from a front view thereof.

32. The engaging portion of a screwdriver defined in claim 24, wherein at least one said outer engaging edge is substantially straight, at least for a short distance, as viewed from a front view thereof.
